(19) United States
(12) Patent Application Publication
(10) Pub. No.: US 2025/0025939 A1
(43) Pub. Date: Jan. 23, 2025

(54) PROCESS FOR RAPID DEBINDERING OF LAID-DOWN, HIGHLY FILLED POLYMER FILAMENTS

(71) Applicant: Bundesrepublik Deutschland, vertreten durch den Bundesminister für Wirtschaft und Energie, dieser, Berlin (DE)

(72) Inventors: Jens GÜNSTER, Clausthal-Zellerfeld (DE); Andrea ZOCCA, Berlin (DE)

(73) Assignee: Bundesrepublik Deutschland, vertreten durch den Bundesminister für Wirtschaft und Energie, dieser, Berlin (DE)

(21) Appl. No.: 18/281,009

(22) PCT Filed: Mar. 2, 2022
(86) PCT No.: PCT/EP2022/055286

§ 371 Date: Sep. 8, 2023

(30) Foreign Application Priority Data
Mar. 10, 2021 (DE) 10 2021 105 769.8

(51) Int. Cl. B22F 10/18; B22F 10/50; B22F 10/64; B22F 10/80; B28B 1/00; B28B 11/24; B33Y 10/00; B33Y 40/20; B33Y 50/00; C04B 35/634; C04B 35/638; C04B 35/64; C04B 35/653

(52) U.S. Cl. CPC B22F 10/18; B22F 10/50; B22F 10/64; B22F 10/80; B28B 1/001; B28B 11/243; B33Y 10/00; B33Y 40/20; B33Y 50/00; C04B 35/634; C04B 35/638; C04B 35/64; C04B 35/653; B22F 2304/10; B22F 2998/10; B22F 2999/00; C04B 2235/5436; C04B 2235/6026; C04B 2235/656; C04B 2235/665

(57) ABSTRACT

A fused deposition modeling process for producing a component is disclosed. In one example, the process comprises at least partial melting of a polymer filament filled with ceramic and/or metallic particles; applying a first layer of the at least partially melted polymer filament according to a first layer of a layer model of the component; allowing the layered, polymer filament to solidify; repeated layer-wise applying of the at least partially melted polymer filament successively on a previously applied and solidified layer according to layers subsequent to the first layer of the layer model until a blank of the component is present; and debinding of the component. Prior to the repeated layer-wise applying an at least sectional exposure to a laser radiation takes place.

### TECHNICAL AREA

The invention is in the field of additive manufacturing and relates to a polymer filament-based process.

### STATE OF THE ART

Thermoplastic molding of ceramic molded parts is increasingly gaining acceptance in industrial companies. Compared to conventional casting and pressing techniques of ceramic components, the burnout of the thermoplastic binder system is more time-consuming. However, in return, easy storage of the feedstock (ceramic-polymer mixture), exact adjustment of the green density, precise production of complex or thin-walled structures, etc. are possible. Compared to conventional thermoplastic forming techniques (injection molding, extrusion), thermoplastic 3D printing of ceramics and metals offers the possibility of producing components individually using a layer-wise structure. Typically, thermoplastic filaments are fed to a heated die via a Bowden extruder. The polymer binder is melted and laid-down at a desired position. Cooling and hardening allow a structure to be built up with a layer thickness of between 0.03 and 1.2 mm, typically 50-200 μm.

Processes that implement this technology for additive manufacturing are called Filament Freeform Fabrication FFF or Fused Deposition Modeling FDM. Currently, polymer filaments filled with ceramic or metallic powders are first stacked or joined together to form a (raw) component, i.e. a blank, using the FDM or FFF process, which is then subjected to debinding by chemical and thermal treatment in preparation for a final sintering process. The sintering process is, of course, also carried out thermally, but at considerably higher temperatures (typically temperatures>1000° C.) than the thermal debinding (typically <650° C.).

Such processes are typically divided into several successive manufacturing steps: —Compounding of the ceramic or metallic powder and the thermoplastic binder; —Production of filament for thermoplastic 3D printing; —3D printing via melting of the feedstock and layer-wise application of the material; and—Thermal treatment (debinding and sintering of the components).

Of course, prefabricated particle-filled polymer filaments can also be used, so these processes can be reduced to 3D printing and thermal treatment, including debinding and sintering.

The terms Filament Freeform Fabrication (FFF) and Fused Deposition Modeling (FDM), which are commonly used in the English-language literature, are referred to synonymously to the German-language Schmelzschichtungsverfahren (i.e. fused layer processes). Fused layer processes are assigned to additive manufacturing, in particular 3D printing. Associated processes of filament production and the use of the filament are to be assigned to the material extrusion processes in the broadest sense.

### Disadvantages of the State of the Art

However, the previously known solutions are only partially satisfactory and require a high level of technical effort. Debinding, i.e. the expulsion of the polymeric portion of the component so that a sinterable ceramic or metallic powder compact (brown body) remains, is one of the most difficult points in the process chain mentioned. The process is time-consuming and, even if the component (green body) is treated very carefully and all the more time-consuming, it always leads to defects due to chemical and thermal debinding. The problem here lies in the fact that there is no open porosity in the green, i.e. as-printed, component. All the spaces between the ceramic or metallic particles are filled with polymer. Therefore, the polymer must first be chemically dissolved, usually in acetone, and then carefully thermally treated to dissolve or evaporate it from the outside in.

In particular, the green body (printed blank of the component obtained) comprises a ceramic or metallic powder bonded by a polymer. However, this blank of the component does not have open pores that would greatly facilitate the escape of volatile components during debinding. Thus, the green body is better described as a polymer body filled with ceramic or metallic powder. The decomposition of the polymer during debinding takes place in a time-consuming process from the outside to the inside.

### Problem

It is therefore the object of the present invention to provide a process for creating an open porosity of a blank of the component, or an open-pored green body still in the printing process.

### Solution According to the Invention

This object is solved by a process according to claim 1 by partial removal of the polymer using a radiation source after each layer application. Further embodiments, modifications and improvements result from the following description and the appended claims.

According to one embodiment, a fused deposition modeling process for manufacturing a component is proposed. The proposed process comprises the process steps:
at least partial melting of a polymer filament filled with ceramic and/or metallic particles;
applying a first layer of the at least partially melted polymer filament according to a first layer of a layer model of the component;
allowing the layer-wise applied, at least partially melted polymer filament to solidify;
repeated layer-wise applying of the at least partially melted polymer filament successively on a previously applied and solidified layer according to layers subsequent to the first layer of the layer model until a blank of the component is present; and
debinding comprising a removal of the solidified polymer of the blank of the component and sintering of the ceramic and/or metallic particles to the component;
   wherein prior to the repeated layer-wise applying, an at least sectional exposure of the previously applied and solidified layer of the at least partially melted polymer filament to a laser radiation takes place.

Advantageously, the manufacturing of components can thus be facilitated and accelerated, since an open porosity penetrating the component in each layer is generated at least at certain positions treated with the electromagnetic radiation. This porosity ideally penetrates the component in the plane of a layer from one outer contour of the layer to the nearest opposite outer contour.

According to one embodiment, the electromagnetic radiation is selected and adjusted so that polymer present in interstices of mutually adjacent ceramic and/or metallic particles of the layered filament decomposes and/or vaporizes when a suitable exposure time is selected so that the blank of the component comprises open pores layer-wise.

Advantageously, the particle interstices exposed as open pores facilitate thermal treatment, in particular debinding, in that gases occurring during thermal debinding can escape unhindered and do not violate an arrangement of the particles of the component blank (“green body”) adjacent to one another.

According to one embodiment, dimensions of applied layers of the at least partially melted polymer filament correspond to dimensions of corresponding layers of a layered model of the component.

According to one embodiment, the model of the component is a CAD/CAM model.

According to one embodiment, the laser radiation applied to a previously applied layer of the polymer filament for debinding is pulsed, wherein the length of pulses of the laser radiation is in a range from one or a few femtoseconds to one or a few μs, preferably up to <1000 fs, more preferably up to <100 fs.

Advantageously, laser radiation, for example focused laser radiation, can be directed over the layer in a software-controlled manner using a scanner device, for example a mirror scanner, and controlled, for example, in terms of intensity, dwell time, rate of progress, wavelength and/or pulse duration in such a way that a polymer (or a polymer component) of the filament used as a binder is decomposed and/or vaporized. Both continuously applied laser radiation or pulsed laser radiation with pulse lengths of fs to μs can be used here. Short pulses, especially in the femtosecond pulse length range, have the advantage that the ceramic material is not already thermally sintered during the process. The wavelength of the laser radiation can extend into the IR, for example up to 800 nm, up to 1800 nm or up to 4.5 μm.

According to one embodiment, the at least partial exposure of the previously applied layer of the at least partially melted polymer filament comprises, for example, lines adjacent to one another and thus forms, for example, a hatching. Likewise, the exposure of the layer to the laser radiation can also take the form of a periodically repeating grid and/or as a pattern, so that the exposed area of the layer is subjected to structuring in an ordered or disordered manner. In particular, a patterning of the respectively exposed layer extending into the depth of the layer is generated.

Advantageously, the interparticle spaces are exposed. This means that polymer is removed—at least partially or even completely—from the interstices of particles adjacent to each other in the solidified layer. However, the polymer is removed only in sections, so that the polymer acting as a binder still fixes the generated particle arrangement according to the control data (CAD-CAM data) of the layer model of the component.

According to one embodiment, an average layer thickness of the solidified, layer-wise applied at least partially melted polymer filament is 25 μm-5,000 μm, preferably 30 μm-3,000 μm, further preferably 50 μm-1,200 μm, in particular 50 μm-200 μm.

Advantageously, a reduction in the layer thickness results in finer structuring of the surface. It is obvious that a component made up of several thin layers can be structured more finely than a component of identical height (size) comprising fewer layers of greater thickness.

According to one embodiment, a depth of the open pores created in the interstices of mutually adjacent ceramic and/or metallic particles extending orthogonally to a plane of the layer comprises between one-fifth and one-half of the average layer thickness of the solidified, layered at least partially fused polymer filament.

This enables reliable stability of the component blank built up step by step by consecutive bonding of adjacent layers. Advantageously, the positions of the areas locally debonded by laser in the respective layer plane are varied in relation to previous layer planes. This ensures the stability of the blank.

According to one embodiment, thermal debinding is performed at a temperature typically below 800° C., in particular below 650° C.

Advantageously, the binder escapes continuously over a wide temperature range, building up a constant vapor pressure controllable by temperature, which can be kept below the destruction threshold of the component to be debonded by selecting the heating program.

According to one embodiment, the polymer filament applied in layers is filled with ceramic particles and/or with metallic particles in a proportion of 50 vol-% to 80 vol-%, preferably up to a proportion of 60 vol-%.

Advantageously, this enables high resulting densities of the sintered component, which in turn enable extended service life and higher mechanical stability.

According to one embodiment, a diameter of the ceramic and the metallic particles that can be determined by microscopy, electron microscopy or dynamic light scattering is 0.2 μm-100 μm, preferably 5 μm-50 μm.

Advantageously, smaller particle diameters enable reduced porosity of the finished component. A specifically adjusted particle size distribution enables the physicochemical properties of the sintered ceramic component to be optimized.

The above-described embodiments may be combined with each other in any desired manner. However, the invention is not limited to the specific embodiments described, but may be suitably modified and varied. It is within the scope of the invention to suitably combine individual features and combinations of features of one embodiment with features and combinations of features of another embodiment to arrive at further embodiments according to the invention.

### DETAILED DESCRIPTION

According to the invention, the previously known printing process is intervened in such a way that, after each laid-down layer, a focused laser beam vaporizes part of the polymer of the layer laid-down in each case before a subsequent layer is laid-down, so that an open porosity is created successively throughout the entire component during the buildup of the component, allowing rapid chemical and thermal debinding.

To do this, after each layer of the component has been completed, the extruder print head of the FDM printer is moved to the side so that the top layer of the component can be conveniently irradiated by a laser. Now, a laser optic (e.g., mirror scanner) guides a focused laser beam over the surface of the layer and locally vaporizes a portion of the polymer. In the process, the laser beam or its focus can also be guided in the form of a pattern on the surface of the upper layer in question. The particular pattern on the layer which is traced by the laser spot depends on various parameters, but is not essential to the invention. Only so much polymer should not be evaporated that there is exclusively completely loose powder on the surface of the layer, since no new polymer layer could firmly adhere to it. This strength is needed to lay-down the filament of the next (subsequent) layer in a securely fixed manner. Just enough polymer is evaporated to maintain an open porosity substantially parallel to a plane of the stacked layers even after the subsequent layer is laid-down, and to connect this open porosity to the outer contour of the component so that gases can easily pass from the inner volume of the component to its outer surface or openly accessible inner surfaces of the component during debinding.

The energy of the laser or the energy in the laser focus is adjusted in such a way that, due to a selected speed of progress of the laser, i.e. adapted to the polymer filament, in the case of continuous movement of the laser (laser focus), or due to a coordinated dwell time of the laser spot (laser focus) in combination with a selected intensity (power density), continuous or pulsed, of the laser and its stepwise, for example raster-like or continuous movement, the locally generated temperature results in reliable—at least partial—removal of the polymer from interstices of mutually adjacent solid particles (metallic or ceramic particles) of the layer concerned down to a predeterminable depth, but no sintering process starts yet.

Thus, the pores thus created also extend into the depth of the layer in question. For example, for a layer of 100 μm, the depth of the particle interstices exposed from the surface into the depth of the layer concerned can extend to 20 μm or 25 μm. The subsequently applied, i.e. subsequently bonded, filament layer partially closes the opened interparticle spaces again, but open pores, similar to branched channels, remain in the successively built-up component.

In other words, after each layer of the part is completed in the FDM process, the top layer of the part is irradiated with a radiation source, such as a laser, so that some of the polymer of the top layer is removed and bonded to the outer contour of the part in such a way that gases can easily escape from the inner volume of the part to its outer surface or openly accessible inner surfaces of the part during debinding. This can be done by means of decomposition but also simply by means of evaporation. The result is a body built up by means of FDM, the individual layers of which have an open porosity throughout. The blank of the component is porous layer-wise, as it were, with a predominant spatial orientation of the open pore spaces extending parallel to the layer plane. Advantageously, this enables faster and safer (in terms of component quality) debinding of ceramic or metallic components additively manufactured by means of FDM/FFF.

The invention can be outlined by the following aspects:
1. Laying-down a layer of a meltable thermoplastic polymer, which is filled with ceramic and/or metallic powder particles, in the form of individual filaments, according to the FDM/FFF material extrusion process, and subsequently irradiating this layer with high-energy laser radiation for the purpose of partial evaporation of the polymer from particle interstices and laying-down a subsequent (second or further) layer, the laser irradiation process being repeated for each laid-down layer.
2. The polymer is highly filled with the ceramic and/or metallic powder (up to 60 vol %).
3. Continuous or discontinuous movement of the laser or the focus of the laser on the uppermost layer of the layer-wise generated component in accordance with a pattern corresponding to the component and completely covering (covering) the latter over its entire cross-sectional area of the respective uppermost layer or scanning it in individual fine lines, so that the polymer contained in the respective layer-wise laid-down filament is vaporized over the entire area or in a grid on the surface of the respective uppermost layer.
4. Formation of open pores in the respective laser-exposed layer or throughout the still unsintered component in such a way that the open porosity is connected to the outer contour of the component so that gases can easily pass from the inner volume of the component to its outer surface or openly accessible inner surfaces of the component during debinding.

In summary, the invention can be described as a fused deposition modeling process for producing a component, comprising: at least partial melting of a polymer filament filled with ceramic and/or metallic particles; applying a first layer of the at least partially melted polymer filament according to a first layer of a layer model of the component; allowing the layered, at least partially melted polymer filament to solidify; repeated layer-wise applying of the at least partially melted polymer filament successively on a previously applied and solidified layer according to layers subsequent to the first layer of the layer model until a blank of the component is present; and debinding comprising a removal of the solidified polymer of the blank of the component and sintering of the ceramic and/or metallic particles to the component; wherein prior to the repeated layer-wise applying, an at least sectional exposure of the previously applied and solidified layer of the at least partially molten polymer filament to a laser radiation takes place.

Although specific embodiments have been shown and described herein, it is within the scope of the present invention to suitably modify the embodiments shown without departing from the scope of protection of the present invention. The following claims represent a first, non-binding attempt to define the invention in general terms.

1. A fused deposition modeling process for producing a component, comprising:
at least partial melting of a polymer filament filled with ceramic and/or metallic particles;
applying a first layer of the at least partially melted polymer filament according to a first layer of a layer model of the component;
allowing the layer-wise applied, at least partially melted polymer filament to solidify;
repeated layer-wise applying of the at least partially melted polymer filament successively on a previously applied and solidified layer according to layers subsequent to the first layer of the layer model until a blank of the component is present; and
debinding comprising a removal of the solidified polymer of the blank of the component and sintering of the ceramic and/or metallic particles to the component;
wherein prior to the repeated layer-wise applying, an at least sectional exposure of the previously applied and solidified layer of the at least partially melted polymer filament to a laser radiation takes place.

2. The fused deposition modeling process according to claim 1, wherein the laser radiation is selected and adjusted to decompose and/or vaporize a polymer present in interstices of mutually adjacent ceramic and/or metallic particles such that the blank of the component comprises open pores layer-wise, that the open pores are connected to an outer contour of the component so that gases can easily pass from an inner volume of the blank to an outer surface of the blank or to an openly accessible inner surface of the blank during debinding, which facilitate the thermal treatment, in particular the debinding.

3. The fused deposition modeling process according to claim 1, wherein dimensions of applied layers of the at least partially melted polymer filament correspond to dimensions of corresponding layers of a layer-wise constructed model of the component.

4. The fused deposition modeling process according to claim 3, wherein the model is a CAD/CAM model of the component.

5. The fused deposition modeling process according to at claim 1, wherein the laser radiation is pulsed, wherein the length of pulses of the laser radiation is in a range of femtoseconds to microseconds.

6. The fused deposition modeling process according to claim 1, wherein the at least sectional exposure of the previously applied layer of the at least partially fused polymer filament comprises mutually adjacent lines, a grid and/or a pattern of areas of the layer exposed to the laser.

7. The fused deposition modeling process according to claim 1, wherein an average layer thickness of the solidified, layerwise applied at least partially melted polymer filament is 50 μm-200 μm.

8. The fused deposition modeling process according to claim 1, wherein a depth, extending orthogonally to a plane of the layer, of the open pores created in the interstices of mutually adjacent ceramic and/or metallic particles comprises between one fifth and one half of the average layer thickness of the solidified, layered at least partially fused polymer filament.

9. The fused deposition modeling process according to claim 1, wherein debinding takes place at a temperature<650° C.

10. The fused deposition modeling process according to claim 1, wherein the polymer filament is filled up to 60 vol % with ceramic particles or with metallic particles.

11. The fused deposition modeling process according to claim 1, wherein a diameter of the ceramic and the metallic particles that can be determined by microscopy, electron microscopy or dynamic light scattering is in the range of 2 μm-100 μm, preferably in the range of 5 μm-50 μm.

12. The fused deposition modeling process according to claim 1, wherein the polymer filament is filled up to 60 vol % with ceramic particles and with metallic particles.
